(19) United States
(12) Patent Application Publication
(10) Pub. No.: US 2011/0194307 A1
(43) Pub. Date: Aug. 11, 2011

(54) MULTI-DIRECTIONAL LIGHT INCIDENCE BACK LIGHT PLATE

(76) Inventors: Chien-Yuan CHEN, Hsin Tien City (TW); Ying-Te CHUANG, Hsin Tien City (TW)

(21) Appl. No.: 12/902,151

(22) Filed: Oct. 12, 2010

(30) Foreign Application Priority Data
Feb. 9, 2010 (TW) 099202673

(51) Int. Cl. F21V 7/22

(52) U.S. Cl. 362/612

(57) ABSTRACT

A multi-directional light incidence back light plate includes a plurality of light bars of high light transmittance arranged to juxtapose each other to form a plate like or a grating like structure. Each light bar has opposite ends to which light sources of light-emitting diode (LED) are mounted so that light emitting from the light sources transmits through the light bar to form a uniform luminous cylinder, which serves as a primary light source for backlighting. A plurality of secondary light sources is arranged at sides of the primary light source to constitute a complete arrangement of a back light plate. The secondary light sources are composed of red light and green light that are combined with the light bar at a predetermined ratio so that various color lights are used to generate excellent color saturation (Ra).

### (a) TECHNICAL FIELD OF THE INVENTION

The present invention generally relates to a structure of back light plate featuring multi-directional light incidence, and more particularly to a back light source for use in a backlight module of a display screen.

### (b) DESCRIPTION OF THE PRIOR ART

Backlighting is a fashion of lighting used in a liquid crystal display (LCD). The backlighting is realized through a back light plate, which is generally classified as two types, namely edge type and direct type. Reference is now made to FIG. 6, which shows a back light plate for a large-sized LCD, wherein each of four sides of the back light plate, generally designated at 50, is provided with a powerful light source 60 to supply sufficient emission of light to the back light plate 50. This back light plate has a disadvantage that the use of four light sources increases the costs and further, the central zone gets apparently dark if two opposite light sources 60 are removed. In order to overcome the problem of costs, as shown in FIG. 7, a modified structure of back light plate provides only two light sources 80 on the opposite sides of the plate 70, so that the costs can be reduced. However, the lighting may be insufficient at the central zone of the plate, and to overcome such a problem, the plate 70 forms a plurality of densely distributed projections 71, the distribution being increasingly denser toward the central zone of the plate for concentration of light on the central zone to improve the problem of non-uniform lighting. But, this raises another problem. The back light plate 70, which may be of a large size, is made very thin and the formation of the projections 71 that are distributed in a density variable manner will lead to deformation or cracking due to shrinkage occurring in a molding process and eventually raising the costs for manufacturing is increased and the process requires additional costs of labor and mechanical installation.

A direct type back light plate is shown in FIG. 8, wherein the back light plate 50 forms a plurality of fitting slots 51 each receiving a light-emitting diode 52 to fit therein to form a structure of back light plate having densely distributed spot light sources. The dense arrangement of the light-emitting diodes 52, which may be high power light-emitting diodes, increases the number of parts, makes soldering difficult, and requires high expenses of manufacturing and maintenance. Further, heat dissipation is another problem for the densely arranged light-emitting diodes 52. This is a bottle neck for the technology of large-sized back light plate.

Another direct type of back light plate uses slender lighting tubes as light sources, which are formed of slender light tubes that are brittle and thin and are easy to break, eventually leading to raised manufacturing costs. This back light plate is of no solution to the existing problems.

Further, most of the light-emitting diodes that emit white light are formed of blue light-emitting diode and phosphor is applied to convert some or all of the light into one or more other colors, which are light of longer wavelength. When these lights of different colors are mixed, the mixed light visually looks like white light. For example, white light can be obtained by combining a blue light-emitting diode with yellow phosphor powders. However, the “white light” obtained in this way is not a “true” white light, but just looks like white by human eyes. This “substitute” white light is not of the best color of white light. Further, in the generation of white light through conversion with a blue light-emitting diode and phosphor, a fraction of energy is converted to heat and this is a loss of energy. Another solution of generating white light is to mix lights of blue, red, and green, but the saturation (Ra) is reduced by approximately 30%. A back light plate that overcomes all the above discussed problems will be a breakthrough in this industry.

### SUMMARY OF THE INVENTION

The primary objective of the present invention is to arrange a plurality of light bars of high light transmittance by juxtaposing the light bars to form a plate like or a grating like structure. Each light bar has opposite ends to which light sources, such as light-emitting diodes (LEDs), are mounted so that light emitting from the light sources transmits through the light bar to form a uniform luminous cylinder, which serves as a primary light source for backlighting. Additionally, a plurality of secondary light sources is arranged at sides of the primary light source to constitute a complete arrangement of a back light plate. The secondary light sources are composed of red light and green light that are combined with the light bar at a predetermined ratio so that various color lights are used to generate excellent color saturation (Ra). This arrangement saves the number of light-emitting diodes used, makes the manufacturing easy, improves color saturation and uniformity of brightness, and can be manufacturing with a simple process, so as to lead to a significant reduction of manufacturing costs.

Another objective of the present invention is to form a light guide slot in an inside surface of the light bar of high light transmittance, wherein the light guide slot is arranged in a more closely distributed manner at a central portion of the light bar, so that the light emitting from the light sources on the two ends of the light bar can be uniformly distributed through the light bar thereby making the light uniform and providing an excellent result of uniform mixture of light.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a plan view schematically showing a structure of back light plate according to the present invention.

FIG. 2 is a cross-sectional view showing a secondary light source arranged at one side of the back light plate according to the present invention.

FIG. 3 is a cross-sectional view showing an arrangement of light sources of the back light plate according to the present invention.

FIG. 4 is an exploded view showing a light bar that constitutes partly the back light plate according to the present invention.

FIG. 5 is a schematic perspective view illustrating inside details of the light bar according to the present invention.

FIG. 6 is a schematic plan view of a conventional edge type back light plate.

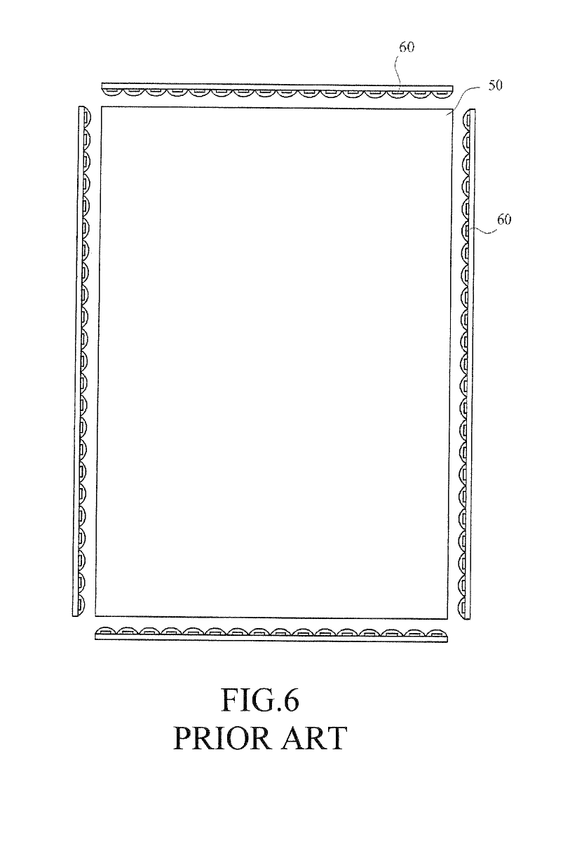

FIG. 7 is a schematic plan view of another conventional edge type back light plate.

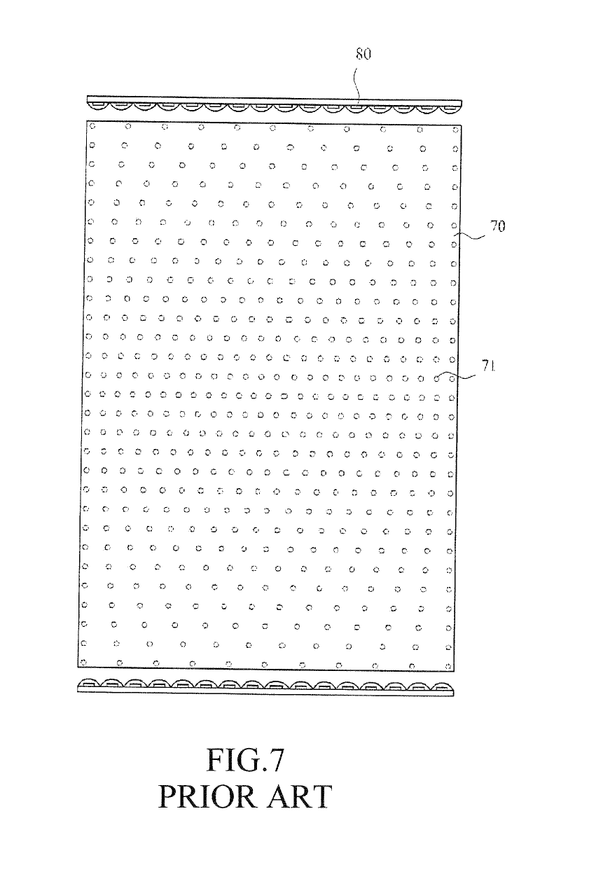

FIG. 8 is a schematic plan view of a conventional direct type back light plate.

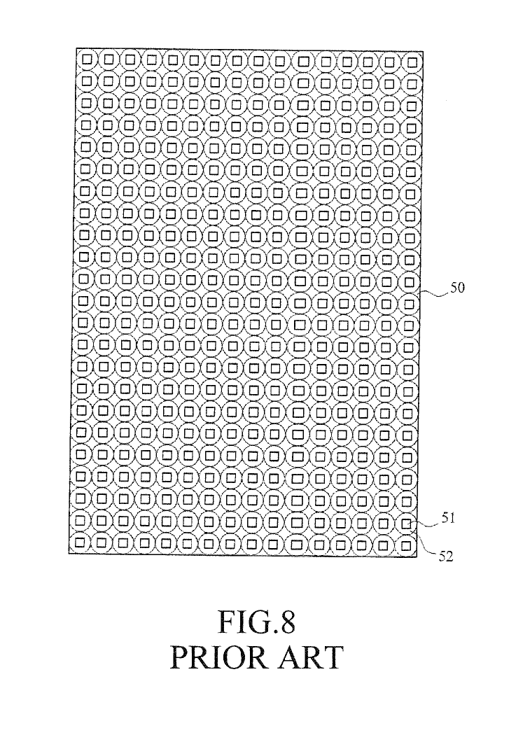

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

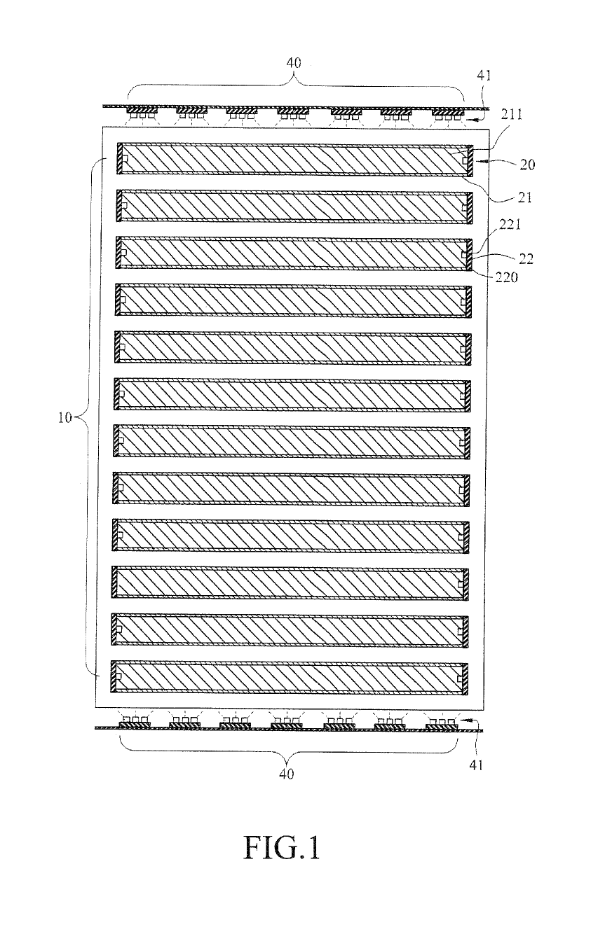

Referring to FIG. 1, the present invention provides a back light plate 10, which comprises a plurality of light bars 20 of high light transmittance arranged to juxtapose but space from each other by a predetermined interval to form a grating like structure, which serves as a primary light source, and a plurality of secondary light sources 40 arranged at sides for mixture light, so that the back light plate of the present invention provides improved uniform light and offers excellent color saturation (Ra) through combination of three color light.

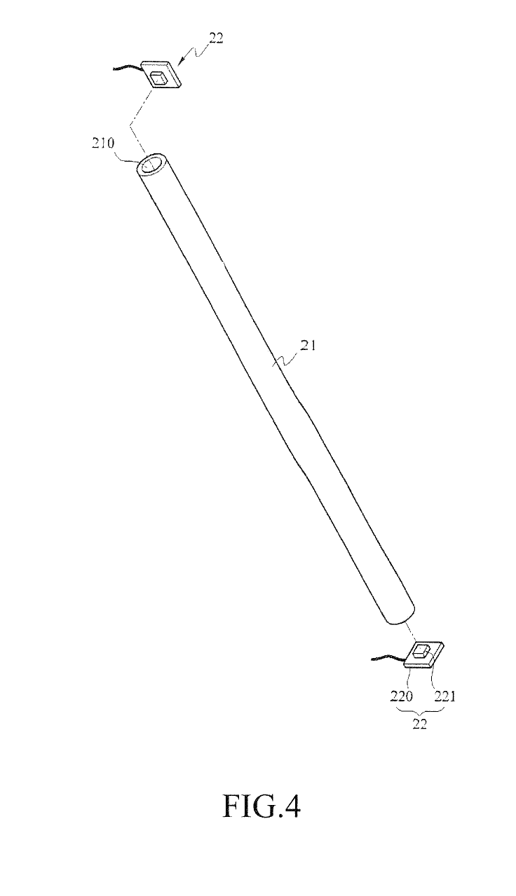

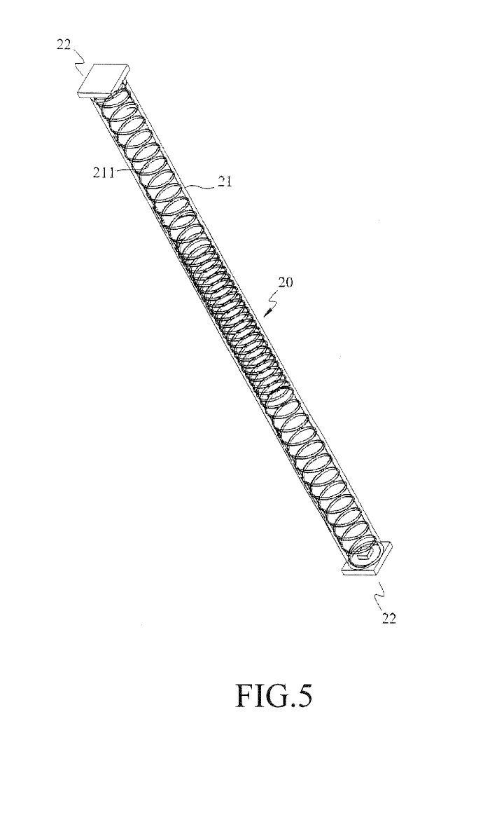

Referring to FIGS. 1, 4, and 5, the back light plate 10 of the present invention generally comprises a plurality of light bars 20, which is structurally different from a regular lighting tube in that the light bar 20 comprises a flexible tubular body 21 of high light transmittance forming centrally a bore 210 that extends axially through the light bar. The tubular body 21 has an inside surface in which a helically extending light guide slots 211, which is composed of multiple helical turns. The light bar may have a single one of light guide slot 211, as shown in FIG. 5, or multiple light guide slots, which are not shown in the drawing due to the similarity of the slots. It is noted that the light guide slot can be arranged in a density variable manner. For example, a preferred embodiment includes turns of the light guide slot 211 are distributed densely at a central portion of the light bar and sparely at end portions, and the change of the distribution is made in a gradually increasing manner. Further, the tubular body 21 of each light bar 20 has two opposite ends to each or any of which a light source 22 is mounted. The light source 22 comprises at least one light-emitting diode (LED) 221 and a control circuit board 220. The number of LED 221 used for each light source can be increased or decreased as desired according to a practical requirement. An example of a single LED 221 is taken in the embodiment illustrated for explanation of the present invention. Further, the LED 221 can be of any desired specification and there is no constraint for that. For example, the LED 22 can be a surface-mounted LED or a two-pin through-hole type LED.

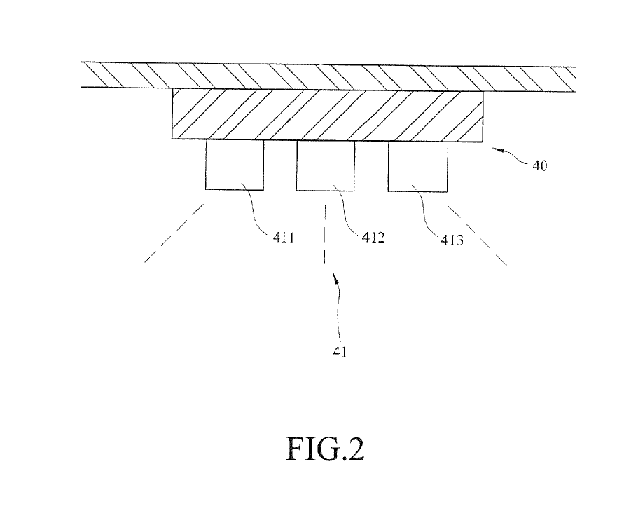

Referring to FIGS. 1 and 2, the secondary light source 40 is composed of three LEDs 411, 412, 413 that collectively form a unit group, forming a combined light source 41. The three LEDs 411, 412, 413 can be arranged at the two sides of the plurality of light bars 20 in a pattern of fore example green-red-red or red-red-green.

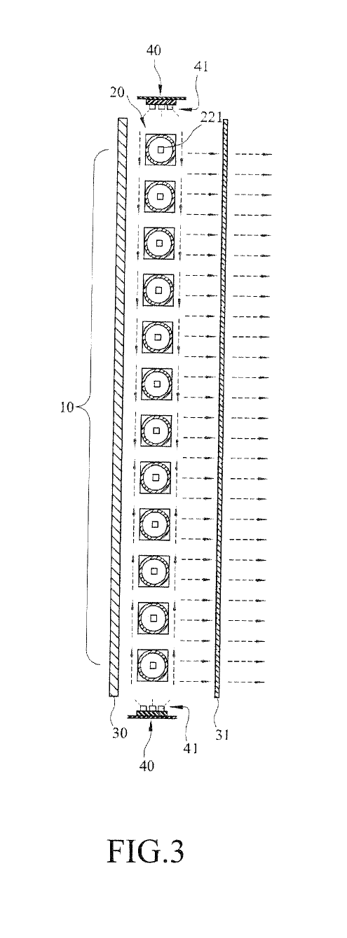

To use the present invention, as shown in FIGS. 1-3, the plurality of light bars 20 collectively serves as a primary light source for the back light plate 10, and the plurality of secondary light sources 40 are arranged at two sides of the plate and each composed of a unit group of three LEDs 411, 412, 413, which forms a combined light source 41 adopting a pattern of green-red-red or red-red-green to emit light toward the centrally located light bars 20. The LEDs 221 of the light bars 20 are white light. Thus, the combination of light made in this way provides a white light of excellent sufficient color saturation (Ra) and sufficient lighting. When the back light plate of the present invention is applied to a display screen, a polarizing plate 31 can be set on a front surface of the back light plate 10 and a reflection plate 30 set on a rear surface. The reflection plate 30 has a high reflection surface and can be made in the form of a curved shape, such as paraboloid, that reflects light back to the front side of the back light plate. Thus, the plurality of light bars 20 of high light transmittance, after emission of light from the light sources 22 mounted to the ends of each of the light bars 20, guides the light through the tubular body 21 to form a luminous cylinder. The light exiting the light bar 20 is made uniform by the density variable arrangement of light guide slot 211, whereby the light bars 20, each of which provides uniform emission of light therefrom, are composed together to form a back light plate 10 of a desired width.

An alternative arrangement of the secondary light source 40 is that, besides the unit group formed of three LEDs 411, 412, 413, the secondary light source 40 further comprise a yellow LED (not shown) to provide even improved color saturation.

In summary, the present invention offers the following advantages:

(1) The present invention provides a back light plate, which comprises a plurality of light bars made of a material of high light transmittance to server as a primary light source and secondary light sources arranged on two sides to serve as auxiliary lighting, which is preferably each formed of a unit group of three LEDs arranged in a green-red-red or red-red-green pattern to project light toward the centrally located light bars, wherein the light bars comprise LEDs that are of white light, whereby with such a combination of lights, a white light of excellent color saturation (Ra) and sufficient lighting can be obtained. This is the primary advantage of the present invention.

(2) The light bar provided by the present invention comprises a light guide slot formed in an inside surface of the light bar and the light guide slot is arranged in such a way that it is of a dense distribution of the helical turns thereof in a central portion of the light bar, so that light emitting from LEDs on the ends of the light bar can be uniformly distributed through the light bar, thereby making light uniform. This is another advantage of the present invention.

(3) When compared to the conventional edge type back light plate, the present invention provides a design that saves parts costs as compared to the design having light sources set on four sides and that makes the manufacturing easy as compared to the dual-surface type large-sized thin plate and the product flaw rate is low, the manufacturing and assembling of the parts are simple. Further, a white light of excellent color saturation can be obtained through mixing of lights according to the present invention. This is a further advantage of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-directional light incidence back light plate comprising:
a plurality of light bars, each of which comprises a flexible tubular body of high light transmittance, the tubular body of each of the light bars having opposite ends to each of which a light source is mounted, the light source comprising at least one light-emitting diode and a control circuit board; and
a plurality of secondary light sources, which is arranged at two sides of the plurality of light bars, each of the secondary light sources comprising a plurality of light-emitting diodes, which together form a unit group to provide a combined light source, the light-emitting diodes comprising green and red light-emitting diodes.

2. The multi-directional light incidence back light plate according to claim 1, wherein the tubular body of each of the light bars has an inside surface forming a continuously extending light guide slot.

3. The multi-directional light incidence back light plate according to claim 2, wherein the tubular body forms more than one light guide slot in the inside surface thereof.

4. The multi-directional light incidence back light plate according to claim 2, wherein the light guide slot is helical.

5. The multi-directional light incidence back light plate according to claim 2, wherein the light guide slot is helical and is arranged to have a denser distribution in a central portion of the light bar than that of two end portions.

6. The multi-directional light incidence back light plate according to claim 1, wherein each of the secondary light sources comprises three light-emitting diodes in a unit group.

7. The multi-directional light incidence back light plate according to claim 6, wherein the three light-emitting diodes are arranged in a pattern of green-red-red.

8. The multi-directional light incidence back light plate according to claim 6, wherein the three light-emitting diodes are arranged in a pattern of red-red-green.

9. The multi-directional light incidence back light plate according to claim 1, wherein the light-emitting diodes of each of the light bars are of white light.

10. The multi-directional light incidence back light plate according to claim 1, wherein each of the secondary light sources comprises a plurality of light-emitting diodes, which comprises a yellow light-emitting diode.
